(19) United States
(12) Patent Application Publication
(10) Pub. No.: US 2009/0055928 A1
(43) Pub. Date: Feb. 26, 2009

(54) METHOD AND APPARATUS FOR PROVIDING PHISHING AND PHARMING ALERTS

(76) Inventors: Jung Min KANG, Daejeon (KR); Do Hoon LEE, Daejeon (KR); Eng Ki PARK, Daejeon (KR); Choon Sik PARK, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/056,375

(22) Filed: Mar. 27, 2008

(30) Foreign Application Priority Data
Aug. 21, 2007 (KR) 10-2007-0083896

(51) Int. Cl. G06F 21/00

(52) U.S. Cl. 726/22

(57) ABSTRACT

Provided is an Internet information security technique, and more particularly, a method for alerting a user that a connected web site is a phishing site by comparing connected web site information with normal site information.

To this end, the method includes the steps of: (a) extracting information on a presently connected site; (b) if information on a normal site having the same domain as the connected site exists in a database, comparing the connected site information with the normal site information; and (c) if the connected site information does not match the normal site information, alerting a user that the connected site is a phishing site. Therefore, the user may safely use the Internet by confirming whether the connected web site is a phishing site.

### CROSS-REFERENCE TO RELATED APPLICATION

This application claims priority to and the benefit of Korean Patent Application No. 2007-83896, filed Aug. 21, 2007, the disclosure of which is incorporated herein by reference in its entirety.

### BACKGROUND

1. Field of the Invention

The present invention relates to Internet information security technology, and more particularly, to a method and apparatus for providing phishing and pharming alerts based on a white list.

2. Discussion of Related Art

With sharp development and spread of information systems and the Internet in recent times, the value of the information prevalent on the Internet has been increasing daily. Particularly, many finance-related web sites are launched, and the number of users using these sites is also increasing.

These days, malicious techniques such as phishing and pharming for hacking private information coming from or going to these finance-related sites are prevalent.

The term “phishing” is a new Internet financial fraud technique, which attempts to criminally acquire users' private information such as credit card details and bank account details after enticing them to a fake website by e-mail. This term is a compound word of private data and fishing, which originated from fraudulently acquiring private information as if fishing.

One method for preventing phishing is registering phishing web sites in a blacklist, and alerting a user as soon as the user connects to an web site in the black list. Similarly, there is another method of indicating risk of a web site being a phishing site and providing a warning not to approach the site. According to these methods, similar to a misuse detection technique of an intrusion detection system, the information of phishing sites are retained and, when a user connects a website corresponding to one of the phishing sites, it is reported to the user. However, in case that the connected site is an unregistered phishing site, these methods do not deal with it, and regular update of the phishing site information is needed.

Contrarily, there is still another method of providing phishing alerts to a user by comparing an address of a presently connected website with a white list including official Uniform Resource Locators (URLs) of well-known sites, which frequently become targets for phishing. This method allows the user to confirm whether the connected site is a site that the user wants to connect to. However, in case that an original site is hacked to operate as a phishing site, this method does not deal with it.

The term “pharming” is a new computer criminal technique of attempting to steal private information, which aims to redirect a website to another bogus website, by taking away a domain legally owned by a legitimate website, or by changing addresses in domain name systems (DNS) or proxy servers.

A conventional technique for anti-pharming is to alert a user when the hosts file on the user's computer is changed. The hosts file is a file stored on a personal computer (PC), which serves as a domain name system used for set-up and cutoff of network connection. However, alerting the user whenever the hosts file is changed may give anxiety to the user.

Moreover, once the network domain name system installed in the user's PC has been damaged by pharming, connection with the site that the user wants to connect to may not be ensured. The current approach to protect the network domain name system from pharming is keeping the domain name system itself safe, but a method of allowing a PCT to examine whether or not the network domain name system has been damaged by pharming is not yet known.

### SUMMARY OF THE INVENTION

The present invention provides a method and apparatus for providing phishing alerts by comparing connected website information with normal website information.

The present invention also provides a method for making a list of normal websites to determine whether the connected site is a phishing site.

The present invention also provides a method for alerting whether a domain name system in a local network has been damaged by pharming.

The present invention also provides a method and apparatus for alerting whether a hosts file in a system has been damaged by pharming.

Other objects and advantages of the present invention can be understood by the following descriptions and the exemplary embodiments of the present invention.

One aspect of the present invention provides a method for providing phishing alerts, including the steps of: (a) extracting information on a presently connected site; (b) if information on a normal site having the same domain as the connected site exists in a database, comparing the connected site information with the normal site information; and (c) if the connected site information does not match the normal site information, alerting a user that the connected site is a phishing site.

Another aspect of the present invention provides a method for providing pharming alerts, including the steps of: (a) receiving a domain and a corresponding IP address of a presently connected site from a domain name system; (b) comparing the domain of the connected site received from the domain name system with a domain registered in a hosts file; (c) if the domain of the connected site received from the domain name system is the same as that registered in the hosts file, comparing the IP address of the connected site received from the domain name system with an IP address corresponding to that registered in the hosts file; and (d) if the IP address of the connected site does not match the IP address corresponding to that registered in the hosts file, alerting a user that the hosts file has been damaged by pharming.

Still another aspect of the present invention provides a method for providing pharming alerts, including the steps of: (a) receiving an IP address corresponding to a domain name of a web site to be connected from a local network domain name system; (b) receiving the IP address corresponding to the domain name of the web site to be connected from a remote domain name system; and (c) if the IP address received from the local network domain name system does not match the IP address received from the remote domain name system, alerting a user that the local network domain name system has been damaged by pharming.

Yet another aspect of the present invention provides an apparatus for providing phishing alerts, including: a normal site database having normal site information extracted from normal sites or received from a user; a site scanning unit for extracting information on a presently connected site; a normal site determining unit for comparing the connected site information extracted by the site scanning unit with the normal site information stored in the normal site database; and a message output unit for outputting a message indicating that the connected site is a phishing site if the connected site information does not match the normal site information.

Yet another aspect of the present invention provides an apparatus for providing pharming alerts, including: a memory unit for storing a hosts file in which a domain and an IP address corresponding to the domain are registered; a normal site determining unit for receiving a domain and a corresponding IP address of a presently connected site from a domain name system, and if the same domain as the received domain of the connected site is registered in the hosts file, comparing the received IP address of the connected site with an IP address corresponding to the same domain registered in the hosts file; and a message output unit for outputting a message indicating that the hosts file has been damaged by pharming if the IP address of the connected site does not match the IP address corresponding to the same domain registered in the hosts file.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a block diagram of an apparatus for providing phishing alerts according to an exemplary embodiment of the present invention;

FIG. 2 illustrates normal site information according to an exemplary embodiment of the present invention;

FIG. 3 is a flowchart illustrating a process of confirming whether a system hosts file has been damaged by pharming according to an exemplary embodiment of the present invention; and

FIG. 4 is a flowchart illustrating a method for providing phishing alerts according to an exemplary embodiment of the present invention.

### DETAILED DESCRIPTION OF EXEMPLARY EMBODIMENTS

The foregoing and other objects, features and advantages of the invention will be apparent from the following more particular description of exemplary embodiments of the invention, as illustrated in the accompanying drawings.

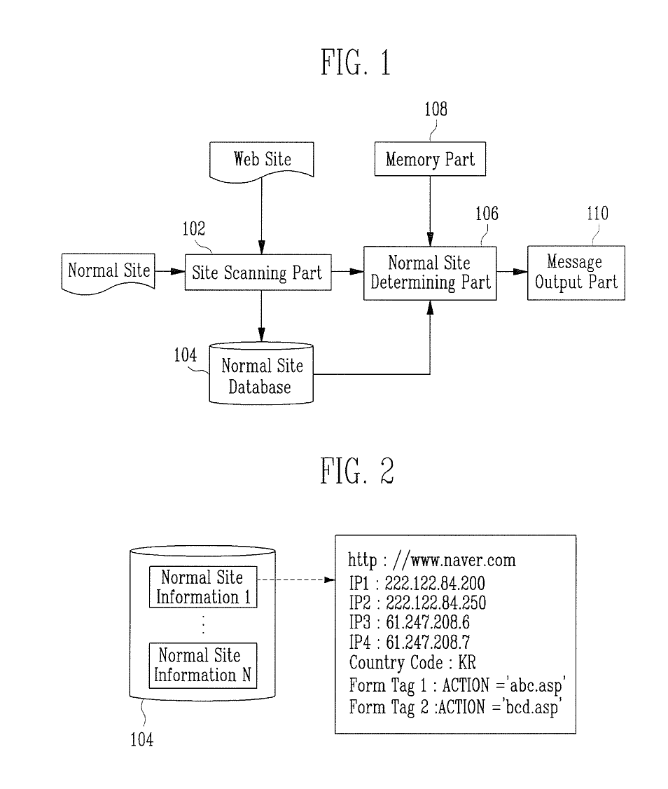

FIG. 1 is a block diagram of an apparatus for providing phishing alerts according to an exemplary embodiment of the present invention. Configuration and operation of the apparatus for providing phishing alerts according to an exemplary embodiment of the present invention will be described in detail with reference to FIG. 1.

The apparatus for providing phishing alerts according to the exemplary embodiment of the present invention includes a site scanning unit 102, a normal site database (DB) 104, a normal site determining unit 106, a memory unit 108 and a message output unit 110.

The site scanning unit 102 according to the exemplary embodiment of the present invention is connected to a web site that is not a phishing site (hereinafter, referred to as a normal site) so as to scan and parse the site, extracts information on the site, and stores it in the normal site database 104. Storing the information in the database may be executed by a user's direct input.

The normal site information may include a domain of the normal site, an IP address, a country code indicating where the site is operated and a form tag included in the normal site. An example of the normal site information according to the exemplary embodiment of the present invention is shown in FIG. 2. Here, a variety of IP addresses may be extracted from one normal site. This is because a specific site uses several IP addresses due to load distribution. For example, as illustrated in FIG. 2, domain ‘http://www.naver.com’ has four different IP addresses, for example, ‘222.122.84.200’, ‘222.122.84.250’, ‘61.247.208.6’ and ‘61.247.208.7.’

Also, the site scanning unit 102 according to the exemplary embodiment of the present invention extracts information from a presently connected web site (hereinafter, referred to as a connected site), and outputs it to the normal site determining unit 106. Here, extraction of the connected site information may be executed after scanning and parsing the connected site in the same manner as that used to extract the normal site information.

The normal site database 104 according to the exemplary embodiment of the present invention stores the normal site information output from the site scanning unit 102. The normal site database 104 may also store the normal site information input from the user.

The normal site determining unit 106 according to the exemplary embodiment of the present invention compares the connected site information with the normal site information stored in the normal site database 104 to determine whether or not the connected site is a phishing site, and outputs the determined result to the message output unit 110.

That is, the normal site determining unit 106 according to the exemplary embodiment of the present invention determines whether the normal site information having the same domain as the connected site exists in the normal site database 104. In the case that the normal site information exists in the normal site database 104, if the connected site information does not match the normal site information by comparing them, the connected site is determined to be a phishing site, and the result is output to the message output unit 110.

Also, the normal site determining unit 106 according to the exemplary embodiment of the present invention determines whether a similar domain to the domain of the connected site exists in the normal site database 104. If a similar domain exists in the normal site database 104, it is determined that the connected site is a phishing site, and the result is output to the message output unit 110.

Here, the normal site determining unit 106 may inquire to the user whether the user will register the connected as a normal site, and may perform registration by a user's input. That is, when receiving the command to register the connected site as a normal site from the user, the normal site determining unit 106 stores the connected site information in the normal site database 104.

Also, if similarity between the domain of the connected site and the domain of the normal site is equal to or greater than a predetermined threshold, it can be determined that both the domains are similar. Whether both the domains are similar may be determined by various similarity calculation algorithms, such as a Ratcliff algorithm, which will be described with reference to Table 1.

Table 1 shows an example of calculating similarities between domains of normal sites and domains which are suspected to be phishing sites.

TABLE 1

| Normal Site | Phishing Site | Similarity (%) |
|---|---|---|
| http://www.usbank.com | http://www.us-bank.com | 97.7 |
| http://www.ameritrading.net | http://ameritrading.net | 98.2 |
| http://comcast.com | http://comcast-database.biz | 66.7 |
| http://www.paypal.com | http://www.paypal-cgi.us | 80.0 |
| http://login.personal.wamu.com | http://www.login.personal.wamuin.com | 95.2 |
| http://www.amazon.com | http://www.amazon-department.com | 79.2 |
| http://www.msn.com | http://www.msnassitance.com | 78.2 |

An example of calculating the similarity between normal site ‘http://www.msn.com’ and phishing site ‘http://msnassistance.com’ with reference to Table 1 will now be described.

The normal site ‘http://www.msn.com’ has 18 characters, and the phishing site ‘http://www.msnassistance.com’ has 28 characters. Here, total sum of common characters included in both the domains is 36, which is 28 (14*2) from ‘http://www.msn’ and 8 (4*2) from ‘.com.’ In this case, the similarity between the two sites will be calculated by dividing 36 (the total sum of the common characters in both the domains) by 46 (the total number of the characters in both domains). Therefore, a percentage of the similarity becomes 78.2% ((36/46)*100).

Here, if the threshold for determining similarity is set to 70%, the similarity between ‘http://comcast.com’ and ‘http://comcast-database.biz’ is 66.7%, and thus, the normal site determining unit 106 does not determine ‘http://comcast-database.biz’ to be a phishing site of ‘http://comcast.com’.

Moreover, if domains of the normal site and the connected site match each other, the normal site determining unit 106 compares IP addresses of the normal site with the IP address of the connected site. Therefore, if neither of the IP addresses matches each other, the normal site determining unit 106 determines the connected site to be a phishing site, and the result is output to the message output unit 110.

This will be described with reference to Table 2.

TABLE 2

| | Connected Site | Normal Site |
|---|---|---|
| Domain | http://www.naver.com | http://www.naver.com |
| . . . | . . . | . . . |
| IP Address | 222.222.222.222 | 222.122.84.200 |
| . . . | . . . | . . . |

When the user is presently connecting the site having the domain ‘http://www.naver.com’ as shown in Table 2, the normal site determining unit 106 searches whether a normal site corresponding to the domain of the connected site is in the normal site database 104. If so, an IP address of the site stored as the normal site is compared with that of the connected site. As shown in Table 2, the IP address of the presently connected site is ‘222.222.222.222’, and the IP address of the normal site stored in the normal site database 104 is ‘222.122.84.200.’ Therefore, the normal site determining unit 106 determines the connected site to be a phishing site, and the result is output to the message output unit 110.

Moreover, if the IP addresses of the normal site domain and the presently connected site domain match each other, the normal site determining unit 106 compares a form tag of the normal site with a form tag of the connected site. Accordingly, if the form tags do not match each other, the connected site is determined to be a phishing site, and the result is output to the message output unit 110.

For example, in the case that an action attribute of a form tag for logging-in to a specific bank site directs to address ‘abc.asp’, if the bank site has been damaged by phishing, so that the address has been changed into ‘http://XXX.com/bcd.asp’, the user may transmit private information such as an ID and a password for logging-in to the bank site to ‘http://XXX.com/bcd.asp’. In order to prevent such a situation, the normal site determining unit 106 may determine whether or not the connected site is a phishing site by comparing the form tag of the connected site with the form tag of the normal site, even when the domains and IP addresses between the normal site and the connected site are a complete match.

Moreover, the normal site determining unit 106 compares a country code of the normal site with that of the connected site. If the codes do not match, the connected site is determined to be a phishing site, and the result is output to the message output unit 110. Here, if the country code of the connected site is repeatedly changed a certain number of times, it may be determined to be a phishing site. That is, for example, if the country code was ‘kr’ in the morning, is changed into ‘us’ in the afternoon, and then is ‘fr in the evening, the site may be determined to be a phishing site. Furthermore, the country code may be shown as an image, which may more clearly alert the user that the country code has been changed.

Moreover, the normal site determining unit 106 may determine whether a hosts file stored in the memory unit 108 of the system has been damaged by pharming. That is, the normal site determining unit 106 receives the domain and its IP address of the connected site by querying the domain name system. If the same domain as the received domain is registered in the hosts file, the corresponding IP address is compared with the IP address registered in the hosts file, and if they are different, the normal site determining unit 106 determines that the hosts file has been damaged by pharming and the result is output to the message output unit 110. Here, the domain name system may be a local network domain name system where the system is included, or an international Internet Service Provider (ISP) DNS.

Simply speaking, pharming of the hosts file is as follows.

For example, there is a system using Windows XP, which has a hosts file in the ‘C:\WINDOWS\SYSTEM32\DRIVER\ETC’ folder, and the file is storing a domain and IP address of web sites. Even if such a system receives a domain name from a user by keyboard input, the system does not request the domain name system to search an IP address corresponding to the domain name, but tries to connect to the IP address registered in the hosts file.

For example, if the real IP address of ‘http://www.naver.com’ is ‘222.122.84.200’, but is changed into ‘222.222.222.222’ by pharming, a keyboard input of ‘http://www.naver.com’ performed by the user goes to the pharming IP address ‘222.222.222.222’, not to the normal IP address ‘222.122.84.200’.

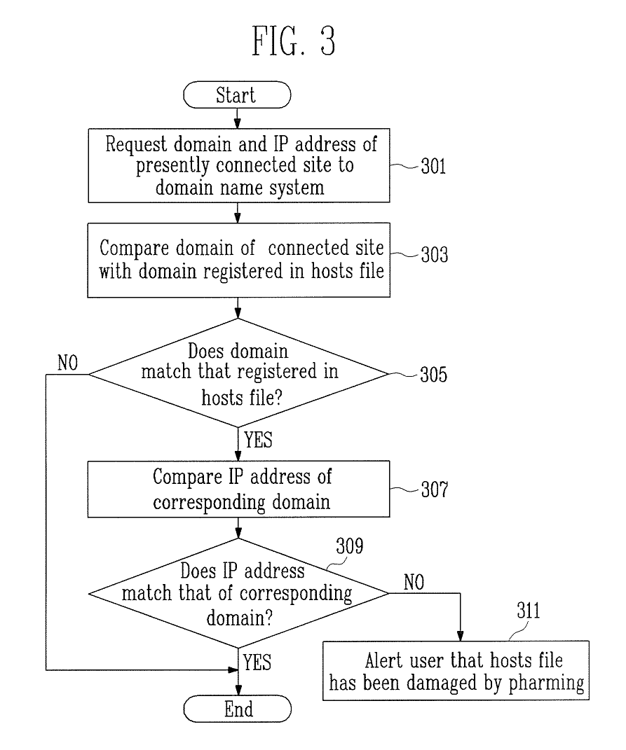

A process of detecting whether or not a hosts fire has been damaged by pharming will now be described with reference to FIG. 3.

FIG. 3 is a flowchart illustrating a process of detecting whether or not a system hosts file has been damaged by pharming according to an exemplary embodiment of the present invention.

In step 301, the normal site determining unit 106 requests and receives a domain and IP address of a presently connected site from a domain name system, and then the process moves to step 303.

In step 303, the normal site determining unit 106 compares the domain of the connected site received in step 301 with that registered in the hosts file, and then the process moves to step 305.

In step 305, the normal site determining unit 106 determines whether a domain corresponding to the domain of the connected site received in step 301 is registered in the system hosts file, and if the corresponding domain is registered, the process moves to step 307.

In step 307, the normal site determining unit 106 compares the IP address of the connected site received in step 301 with that of the corresponding domain registered in the hosts file, and then the process moves to step 309.

In step 309, the normal site determining unit 106 determines whether the IP addresses of the connected site matches that of the hosts file, and if the addresses do not match, the process moves to step 311.

In step 311, the message output unit 110 outputs a message indicating that the hosts file has been damaged by pharming, and thus the process is terminated.

Referring again to FIG. 1, the normal site determining unit 106 according to the exemplary embodiment of the present invention may determine whether the local network domain name system which the presently used system belongs to has been damaged by pharming.

That is, the normal site determining unit 106 receives IP addresses corresponding to a domain name of the web site to be connected from the local network domain name system and a remote domain name system. If neither of the received IP addresses matches each other, the normal site determining unit 106 determines that the local network domain name system has been damaged by pharming, and the result is output to the message output unit 110.

Here, when the IP addresses corresponding to the domain name of the web site to be connected are received from several remote domain name systems, if a ratio of the number of the IP addresses matching to the IP addresses received from the local network domain name system, among the IP addresses received from the several remote domain name systems, to the total number of the IP addresses received from the several remote domain name systems is equal to or greater than a predetermined critical point, it is determined that the local network domain name system has been damaged by pharming, and the result is output to the message output unit 110.

For example, provided that the IP address received from the local network domain name system, which corresponds to the web site address ‘http://www.naver.com’ to be connected, is ‘222.122.84.200’ and IP addresses received from three different remote domain name systems A, B and C which correspond thereto are ‘222.122.84.200’, ‘222.122.84.200’ and ‘222.122.84.250, respectively. Here, in the case that the predetermined critical point is 50%, among three addresses received from servers A to C, two are the same as the IP addresses received from the local network DNS, and thus, the similarity is 66.7%, which is greater than the predetermined critical point, 50%. Accordingly, it can be seen that the local network domain name system has not been damaged by pharming.

The memory unit 108 stores a hosts file in which a domain of a web site and a corresponding IP address are registered.

The message output unit 110 outputs a message according to a phishing or pharming determination result received from the normal site determining unit 106. The message output unit 110 also outputs a message for inquiring whether or not a site suspected to be a phishing site is to be registered as a normal site to the user.

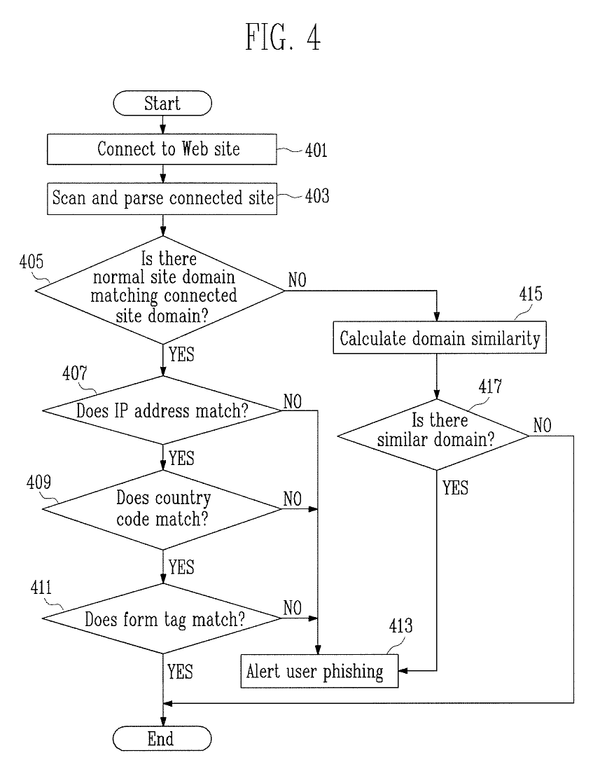

FIG. 4 is a flowchart illustrating a method for providing phishing alerts according to an exemplary embodiment of the present invention. This method will now be described with reference to FIG. 4, however, descriptions overlapping FIGS. 1 to 3 will not be repeated.

In step 401, a user logs on to a web site, and in step 403, the site scanning unit 102 according to the exemplary embodiment of the present invention extracts information on the connected site by scanning and parsing the site.

In step 405, the normal site determining unit 106 searches whether a normal site domain corresponding to the connected site domain is stored in a normal site database 104, and if the domain exists, the process moves to step 407, unless the process goes to step 415.

In step 407, the normal site determining unit 106 compares an IP address of the connected site with that of the corresponding normal site. If both the addresses match, the process moves to step 409, unless the process goes to step 413 to output a message indicating to the user that the connected site is a phishing site through a message output unit 110.

In step 409, the normal site determining unit 106 compares a country code of the connected site with that of the corresponding normal site. if both the codes match, the process moves to step 411, unless the process goes to step 413 to output a message indicating to the user that the connected site is a phishing site through a message output unit 110.

In step 411, the normal site determining unit 106 compares form tag information of the connected site with that of the corresponding normal site. If neither of the form tag information matches, the process moves to step 413 to output a message indicating to the user that the connected site is a phishing site through the message output unit 110.

Meanwhile, in step 415 performed after step 405 of determining that the domain matching the domain of the connected site is not stored in the normal site database 104, the normal site determining unit 106 determines whether a domain similar to the domain of the connected site is stored in the normal site database 104. If the similar domain is stored, the process moves to step 413 to output a message indicating to the user that the connected site is a phishing site through the message output unit 110. Here, as described above, the similarity of the domains may be determined based on the predetermined critical point.

Meanwhile, as described with reference to FIG. 1, if the country code is changed more than a certain amount of times in step 409, the process moves to step 413 to output a message indicating to the user that the connected site is a phishing site through the message output unit 110.

As described above, the present invention may safely use the Internet by confirming whether a connected web site is a phishing site.

Also, the present invention may safely use the connected web site by confirming whether a local network domain name system and a system hosts file have been damaged by pharming.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method for providing phishing alerts, comprising the steps of:
(a) extracting information on a presently connected site;
(b) if information on a normal site having the same domain as the connected site exists in a database, comparing the connected site information with the normal site information; and
(c) if the connected site information does not match the normal site information, alerting a user that the connected site is a phishing site.

2. The method according to claim 1, further comprising the step of:
after connecting to the normal site to scan and parse the normal site,
building a database by storing the normal site information extracted from the parsed normal site.

3. The method according to claim 1, further comprising the step of:
building the database by storing the normal site information received from a user's input.

4. The method according to claim 1, wherein the connected site information and the normal site information comprise at least one of a domain, an Internet Protocol (IP) address, a country code and a form tag.

5. The method according to claim 1, wherein step (b) comprises the step of:
calculating a similarity between a domain of the connected site and a domain of at least one normal site stored in the database, and if the similarity is equal to or greater than a predetermined threshold, alerting a user that the connected site is a phishing site.

6. The method according to claim 5, wherein step (b) further comprises the step of:
receiving a user's input as to whether or not the connected site is to be registered as a normal site.

7. The method according to claim 1, wherein step (c) comprises the step of:
comparing an IP address of the normal site with an IP address of the connected site, and if the addresses do not match each other, alerting the user that the connected site is a phishing site.

8. The method according to claim 1, wherein step (c) comprises the steps of:
comparing an IP address of the normal site with an IP address of the connected site, and if the addresses match each other, comparing a form tag of the normal site with a form tag of the connected site, and if the form tags do not match each other, alerting the user that the connected site is a phishing site.

9. The method according to claim 1, wherein step (c) comprises the step of:
comparing a country code of the normal site with a country code of the connected site, and if the codes do not match each other, alerting the user that the connected site is a phishing site.

10. The method according to claim 1, wherein step (c) comprises the steps of:
storing country codes of the connected site in every connection to the site, comparing the country code of the connected site with country codes stored in advance, and if the country code of the connected site is changed more than a certain amount of times, alerting the user that the connected site is a phishing site.

11. A method for providing pharming alerts, comprising the steps of:
(a) receiving a domain and a corresponding IP address of a presently connected site from a domain name system;
(b) comparing the domain of the connected site received from the domain name system with a domain registered in a hosts file;
(c) if the domain of the connected site received from the domain name system is the same as that registered in the hosts file, comparing the IP address of the connected site received from the domain name system with an IP address corresponding to that registered in the hosts file; and
(d) if the IP address of the connected site does not match the IP address corresponding to that registered in the hosts file, alerting a user that the hosts file has been damaged by pharming.

12. The method according to claim 11, wherein the domain name system is one of a local network domain name system and a remote domain name system.

13. A method for providing pharming alerts, comprising the steps of:
(a) receiving an IP address corresponding to a domain name of a web site to be connected from a local network domain name system;
(b) receiving the IP address corresponding to the domain name of the web site to be connected from a remote domain name system; and
(c) if the IP address received from the local network domain name system does not match the IP address received from the remote domain name system, alerting a user that the local network domain name system has been damaged by pharming.

14. The method according to claim 13, further comprising the step of, when IP addresses corresponding to the domain name of the web site to be connected are received from several remote domain name systems, if a ratio of the number of the IP addresses matching the IP addresses received from the local network domain name system to the total number of the IP addresses received from the several remote domain name systems is smaller than a predetermined threshold, alerting the user that the local network domain name system has been damaged by pharming.

15. An apparatus for providing phishing alerts, comprising:
a normal site database having normal site information extracted from normal sites or received from a user;
a site scanning unit for extracting information on a presently connected site;
a normal site determining unit for comparing the connected site information extracted by the site scanning unit with the normal site information stored in the normal site database; and
a message output unit for outputting a message indicating that the connected site is a phishing site if the connected site information does not match the normal site information.

16. An apparatus for providing pharming alerts, comprising:
a memory unit for storing a hosts file in which a domain and an IP address corresponding to the domain are registered;
a normal site determining unit for receiving a domain and a corresponding IP address of a presently connected site from a domain name system, and if the same domain as the received domain of the connected site is registered in the hosts file, comparing the received IP address of the connected site with an IP address corresponding to the same domain registered in the hosts file; and
a message output unit for outputting a message indicating that the hosts file has been damaged by pharming if the IP address of the connected site does not match the IP address corresponding to the same domain registered in the hosts file.
